(19) United States
(12) Patent Application Publication
(10) Pub. No.: US 2022/0343389 A1
(43) Pub. Date: Oct. 27, 2022

(54) ESTIMATING PRODUCT ATTRIBUTE PREFERENCES

(71) Applicant: salesforce.com, inc., San Francisco, CA (US)

(72) Inventors: Alexander Kushkuley, Ashland, MA (US); Keld Lundgaard, Cambridge, MA (US); Cameron Wolfe, Austin, TX (US)

(21) Appl. No.: 17/230,257

(22) Filed: Apr. 14, 2021

(51) Int. Cl. G06Q 30/06; G06Q 30/02; G06N 20/00; G06N 3/04

(52) U.S. Cl. CPC G06Q 30/0631; G06Q 30/0204; G06N 20/00; G06N 3/0481

(57) ABSTRACT

Methods, computer readable media, and devices for estimating product attribute preferences are disclosed. One method may include identifying a set of users, a set of products offered to users of the set of users, and a set of product attributes associated with products in the set of products, creating a product embedding matrix, an attribute embedding matrix, a user interaction matrix, a product attribute matrix, and a user attribute matrix, assigning an attribute weight to each product attribute, assigning, for each user, a user attribute weight for each product attribute, and displaying the set of products to a user in a ranked order based on the attribute weights and the user attribute weights assigned to the user.

### TECHNICAL FIELD

Embodiments disclosed herein relate to techniques and systems for estimating product attribute preferences and ranking a list of products based on estimated product attribute preferences.

### BACKGROUND

When a user visits a site, such as a website of a retailer, the user may be presented with a list of products. The product list may include products from a product catalog of the retailer and each product may have a number of product attributes associated with the product. For example, an online retailer product catalog may have a few dozen product attributes, such as “product type”, “category”, “price”, “brand”, and the like. The user may have a preference for the various products and such preference may be influenced differently by different product attributes (e.g., some product attributes may be more important than other product attributes).

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system for use with estimating product attribute preferences according to some example implementations.

FIG. 1B illustrates a sample table of user activity history for use with estimating product attribute preferences according to some example implementations.

FIG. 1C illustrates a sample table of product attributes associated with products in a product catalog for use with estimating product attribute preferences according to some example implementations.

FIG. 1D illustrates a sample table of top-ranked product attributes based on estimating product attribute preference according to some example implementations.

FIG. 1E illustrates a sample table of top-ranked product attributes corresponding to various users according to some example implementations.

FIG. 2 is a flow diagram illustrating a method for estimating product attribute preferences according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

In order to improve recommender click-forecasting (e.g., how a product list may be rank ordered), it may be natural to quantify product attribute importance by introducing some kind of a product attribute ranking scheme. This product attribute ranking scheme may depend, for example, on a web site user. That is, some attributes may be more important for some users than for some other users. However, there may also be clearly “most important” attributes that consistently show-up in most of the web site requests. Therefore, various implementations of the disclosed subject matter may consider both personalized attribute ranks (i.e., specific to an identified user) and non-personalized attribute ranks (i.e., site specific attribute ranks). As discussed in greater detail below, both personalized attribute ranks and non-personalized attribute ranks may be modeled in a similar way.

Various implementations may enable a real time reordering of products displayed on a web page based on preferences of a user viewing the page. Some implementations may enable using attribute ranking to reorder or re-weight product ranks calculated by various recommenders. Some implementations may enable using top ranked product attributes to generate a “synthetic” product description. Various implementations may enable clustering products based on top-ranked attributes and/or clustering/segmenting users based on top product attribute preferences.

Implementations of the disclosed subject matter provide methods, computer readable media, and devices for estimating product attribute preferences. In various implementations, a method may include identifying a set of users, identifying a set of products offered to users of the set of users, and identifying a set of product attributes associated with products in the set of products. The method may further include creating a product embedding matrix that may provide a numerical representation of the set of products by embedding the set of products into a vector space, creating an attribute embedding matrix that may provide a numerical representation of the set of product attributes by embedding the set of product attributes into the vector space, and creating a user product interaction matrix that may provide a numerical representation of relationships between the set of users and the set of products based on historical interactions between users of the set of users and products of the set of products. The method may also include creating a product attribute matrix based on the product embedding matrix and the user attribute embedding matrix, creating a user attribute matrix based on the product attribute matrix and the user product interaction matrix, assigning an attribute weight to each product attribute in the set of product attributes based on the product attribute matrix, and for each user in the set of users, assigning a user attribute weight for each product attribute in the set of product attributes based on the user attribute matrix. The method may further include displaying, via a graphical user interface, the set of products to a user in a ranked order based on the attribute weight of each product attribute in the set of product attributes and the user attribute weight for each product attribute in the set of product attributes assigned to the user.

In various implementations, the set of users may include users of a website associated with a retailer and the set of products may be offered to the set of users by the retailer.

In some embodiments, embedding the set of products into the vector space may include generating a vector for each product in the set of products by applying natural language processing techniques to each product.

In some embodiments, the product attribute matrix may be a dot product of the product embedding matrix and the attribute embedding matrix.

In various implementations, creating the product attribute matrix may include utilizing a neural network to learn a non-linear function of elements of the product embedding matrix and elements of the attribute embedding matrix.

In various implementations, creating the product attribute matrix may include generating the product attribute matrix by applying machine learning techniques to a product catalog that defines attributes for the products.

In various implementations, creating a user attribute matrix may include multiplying the product attribute matrix and the user product interaction matrix.

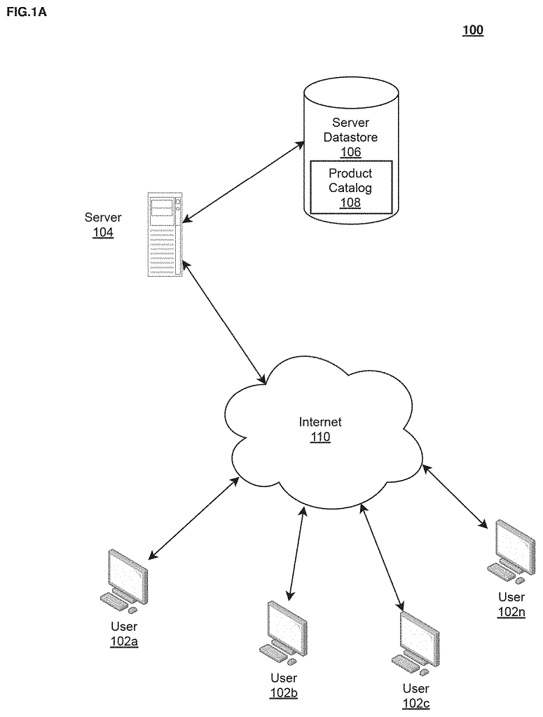

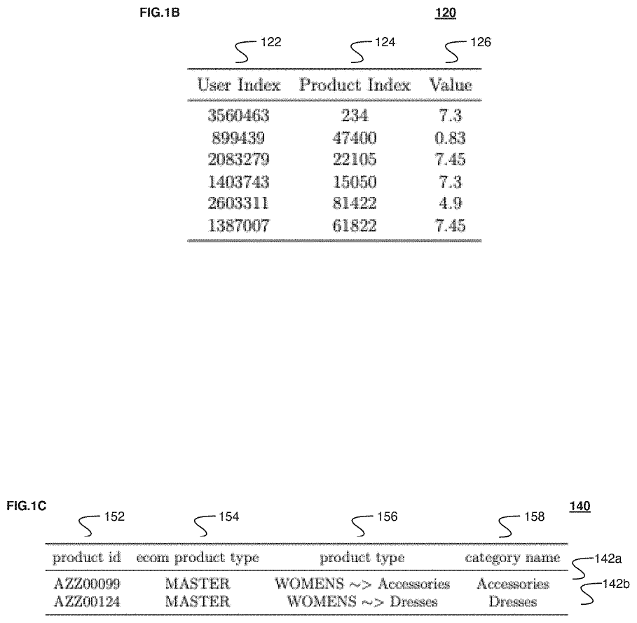

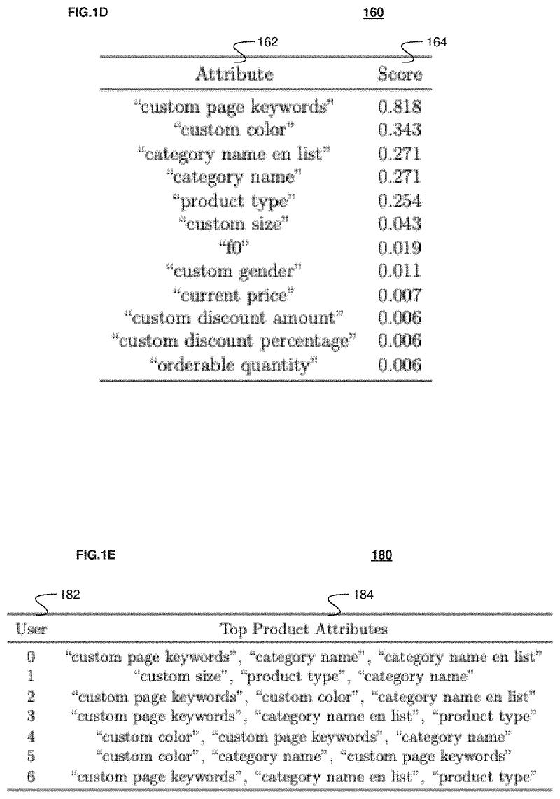

FIG. 1A illustrates a system 100 for use with estimating product attribute preferences according to various implementations of the subject matter disclosed herein. In various implementations, the system 100 may include, for example, users 102a . . . n that access or otherwise connect with server 104 via the Internet 110. Server 104 may reference or otherwise have access to product catalog 108 stored in storage media, such as server datastore 106.

In one example, server 104 may be a website operated by a retailer and users 102a . . . n may be customers of the retailer. In this example, product catalog 108 may include a number of products offered for sale by the retailer as well as various product attributes associated with the products. Of note, while some or all of the products may include common product attributes, the various product attributes may differ for various products. For example, all products may include common product attributes, such as product identifier, product type, category name, or the like. However, in this example, some products may include certain additional product attributes and other products may include different additional product attributes.

When a user, for example, visits the retailer's website, products from the product catalog may be presented to the user. For example, the products may be presented in a list. The retailer may want to have the list ordered based on the user's preferences such that the user will see preferred products first. This may increase the likelihood that the user may select a product and/or otherwise further engage with the website. As such, the ranked order may be based on that user's preferences of product attributes as well as product attribute preferences for all users of the website.

Based on the above, definition and subsequent computation of product attribute ranks may include at least the following three components: 1) numerical model (representation) for products; 2) numerical model (representation) for product attributes; and 3) “historic” user-to-product relationship (numerical representation).

In various implementations, U may represent a set of users, such as users 102a . . . n, P may represent a set of products, such as products included in product catalog 108, and A may represent a set of product attributes. In one example, a standard way to represent these sets (notions) may be to use vector space embeddings. The set of products P may be embedded into an “abstract” vector space [symbol] ⁿ, for example, by using a natural language processing technique. This may result in a |P| X n it product embedding matrix P_{emb}. Similarly, the set of product attributes, for example, may be embedded into the same [symbol] ⁿ, thus obtaining a |A| x n attribute embedding matrix A_{emb}.

Further in this one example, website user interactions with offered products may be represented by a (sparse) |U|X |P| user product interaction matrix U_{P}. Of note, the product embedding matrix and attribute embedding matrix may be relatively “static” in a sense that both depend only on a product catalog and do not include website activity. Hence, both these embeddings may be recomputed at relatively long intervals of time (e.g., every week or every month). On the other hand, user-to-product relationships may include website activity and may be recomputed more frequently (e.g., daily).

In some implementations, a product attribute embedding matrix P_{A} may be constructed in various ways. For example, the product attribute embedding matrix P_{A} may be defined based on the product embedding matrix P_{emb} and the attribute embedding matrix A_{emb}. Given vectors pᵢ, αⱼ ∈ [symbol] ⁿ that correspond to the embeddings of product i and attribute j, an ij matrix element in P_{A} may be defined in one of the following ways: a dot product [symbol] pᵢ, αⱼ [symbol] , that is P_{A}=P_{emb}A^{T}_{emb}; a cosine similarity

$$\frac{〈 {p}_{i} , {a}_{j} 〉}{‖ {p}_{j} ‖ \cdot ‖ {a}_{j} ‖} ;$$

either the dot product or cosine similarity described herein multiplied by a popularity index of a product; using a neural network to learn a non-linear function f(pᵢ, αⱼ); or using machine learning to learn matrix P_{A} directly from existing product catalog data and/or other available textual and/or visual data.

In some implementations, a user attribute matrix, represented as U_{A}, may be computed from a user product interaction matrix (i.e., U_{P}) and a product attribute embedding matrix (i.e., P_{A}) as shown below in Eq. (1).

U_{A}=UₚP_{A} (1)

The embeddings U_{A} and P_{A} may be used, for example, to cluster products by their attribute similarity and/or to segment users by their product attribute preferences. The matrices P_{A} and U_{A} may provide embeddings of both users and products into the same (product attribute) vector space V_{A} where the distance between a user and a product may be computed. In some implementations, a flexible product attribute rank estimator “architecture” may (re)use embeddings described herein as pluggable components. For example, existing product catalog (and other) “in house” embeddings may be used.

In various implementations, site-wide product-attribute ranks (e.g., attribute weights) may be obtained by computing singular value decomposition of the matrix P_{A}.

P_{A}Q₂=Q₁Σ

All entries of the matrix P_{A} are non-negative, and hence by Perron-Frobenius theorem, all entries of the first column of the right multiplier Q₂ can be assumed to be non-negative. These entries are in fact weights of the attributes (as represented by the columns of P_{A}) in the linear decomposition of the top singular vector P_{A} and therefore provide a good representation of the global (site-wide) product attribute ranks.

Personalized attribute ranks (e.g., user attribute weights) may be obtained from the singular value decomposition of the matrix U_{A}. Denoting by X[1:k] the first k columns of a matrix X we have

U_{A}Q₂=Q₁Σ

U_{A}^{(k)}≡U_{A}Q₂[1:k]^{T}=Q₁Σ[1:k]Q₂[1:k]^{T}

It follows from the discussion above that matrix U_{A}^{(k)} is essentially an approximation of U_{A} in a space of top k singular user-attribute vectors. Therefore the rows of U_{A}^{(k)} provide a good representation of the most important user product preferences (as encoded by product attributes). The approximation rank k may be viewed as a standard “noise reduction” versus “good approximation” tune-up parameter.

Product attribute ranks obtained by application of the disclosed subject matter were successfully used to reorder recommended product lists by price in at least one A/B test. Various embedding techniques described above may potentially require some modifications of SVD factorization to cope with “non-linearity” of embeddings used.

As can be seen in the above definitions, both personalized and non-personalized product attribute ranks may depend on product and attribute embeddings. Therefore, attribute ranks thus obtained may be used for the purpose of testing and comparing such embeddings.

User activity history may be a sparse user by product matrix that records user-clicked products weighted by activity type (e.g., view-click, reco-click, purchase) and activity recency. FIG. 1B illustrates a sample of a dataset of user activity history 120 that includes a user index column 122, a product index column 124, and a value column 126. As discussed above, the user/product matrix may be denoted as U_{P}. Of note, the values for user activity (i.e., value column 126) may always fall in the range [0, 10].

FIG. 1C illustrates a portion of a product catalog spreadsheet 140. As shown, product catalog spreadsheet 140 includes a subset of the set of products P, including products 142a, 142b. Product catalog spreadsheet 140 also includes various product attributes, including product ID 152, ecom product type 154, product type 156, and category name 158. Only a few of the products and product attributes are shown for simplicity. The various rows of product catalog spreadsheet 140 correspond to unique products and the various columns correspond to different product attributes within the catalog. As shown in FIG. 1C, column headers represent the names of product attributes, and the value of each attribute for different products may be seen within the column entries.

Pre-processing of product details, such as product catalog spreadsheet 140 of FIG. 1C, may be accomplished in a few steps including, for example, column exclusion, numerical column preprocessing, word counting, and constructing product/word, attribute/word, and product/attribute embedding matrices.

In various implementations, some columns of the product catalog spreadsheet S may be excluded for various reasons. For example, certain columns, such as “product description” and “image url”, may not be useful for product attribute extraction. Similarly, columns with an average attribute value length exceeding 60 characters, columns that have too few non-empty values, and/or columns that have mostly indistinguishable values (e.g., attribute values are the same for all products) may be excluded.

In various implementations, there may be two types of numerical columns that may need additional preprocessing. For example, “real” numerical columns, such as price, may be quantiled and replaced by words “high/low/medium” concatenated with attribute name(s). In another example, “named” numerical columns, such as size or count, may be replaced with words (e.g., 25 may be replaced with the word “twofive”).

In various implementations, exclusion of certain columns and preprocessing of numerical columns, as described above, amount to a transformation of the product catalog spreadsheet S. The resulting spreadsheet (table) may also be denoted by the same letter S. Let [symbol] be a set of “reasonable” words that occur in S. That is, special characters or any remaining numerical values are excluded. Each [symbol] Σ [symbol] may be assigned some number f( [symbol] ) based on various “bags of words” schemes. For example, f( [symbol] ) could be (relative) word frequency (v) or smooth inverse frequency SIF α/(α+v) or just 1. All of the elements of [symbol] may be ordered (e.g., alphabetically) so that [symbol] ={ [symbol] ₁, [symbol] ₂, . . . }. Similarly, all products and attributes may be ordered by some fixed index sets. It may be expected that resulting attribute ranks do not depend on this ordering.

In various implementations, embedding matrices may be obtained in various ways. For example, let A be the set of all attributes in S and let P be the set of all products in S. Two (sparse) matrices may be constructed from S as follows:

An attribute-word embedding |A| X |W| matrix A_{W}; and

A product-word embedding |P| X |W| matrix P_{W}.

By definition, an element of the matrix A_{W} at position i, j may be set to f( [symbol] ⱼ) if attribute indexed by i has word [symbol] ⱼ in corresponding row/column position of S, otherwise this element is set to 0. Similarly, an element of the matrix P_{W} at position i, j is set to f( [symbol] ⱼ) if product indexed by i has word [symbol] ⱼ in corresponding (full) row of S or it is set to 0 otherwise.

Product and user embeddings into product attribute space may be computed as described above (i.e., see Eqs. (2)).

P_{A}=P_{W}(A_{W})^{T}

U_{A}=U_{P}P_{A} (2)

In various implementations, personalized and non-personalized product attribute ranks may be computed from matrices U_{A} and P_{A} as disclosed herein.

FIG. 1D illustrates a sample table 160 of top-ranked attributes for an e-commerce website. As shown, table 160 includes an attribute column 162 and a score column 164. In various implementations, the “score” of an attribute may be given by the corresponding top singular vector coordinate, as discussed above. Similarly, FIG. 1E illustrates a sample table 180 of the top-three attribute preferences, personalized to different website users. As shown, table 180 includes a user column 182 and a top product attributes column 184. Table 180 provides a personalized attribute ranking based on the subject matter disclosed herein.

As disclosed herein, an algorithm and a data model may be used to quantify product attribute ranks and user-product attribute preferences. The various computations involved may be based on product and attribute vector embeddings and may reuse existing natural language processing and/or other embeddings when available.

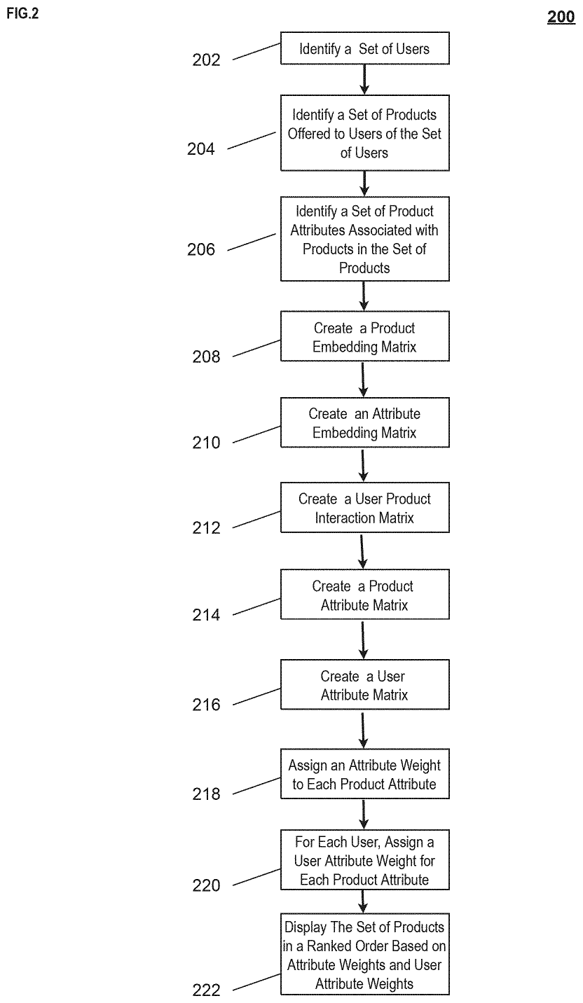

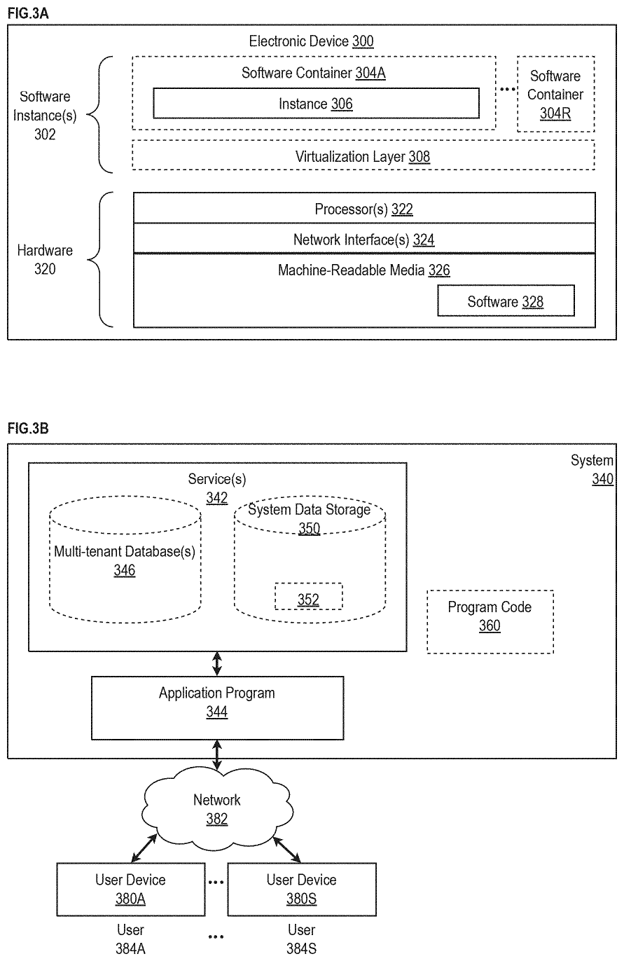

FIG. 2 illustrates a method 200 for estimating product attribute preferences, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, a set of users may be identified. In various implementations, the set of users may be, for example, various users of a website. Such website may be, for example, a retail or other site that offers products and/or services for sale. Thus, the set of users may include, for example, buyers and/or other individuals that have visited and/or otherwise are interacting with the site.

In step 204, a set of products may be identified. For example, the set of products may include products and/or services offered by a website to users of the set of users. In various implementations, the set of products may represent a product catalog, such as product catalog 108 of FIG. 1.

In step 206, a set of product attributes associated with products in the set of products may be identified. In various implementations, product attributes may include, for example, attributes that further define or otherwise describe a product, such as product id, product name, product category, product type, size, price, or the like.

In step 208, a product embedding matrix may be created. For example, the set of products may be embedded into an “abstract” vector space [symbol] ⁿ. Such embedding may utilize, for example, a natural language processing technique.

In step 210, an attribute embedding matrix may be created. For example, the set of product attributes may be embedded into the same vector space [symbol] ⁿ. Such embedding may also utilize, for example, a natural language processing technique.

In step 212, a user product interaction matrix may be created. In various implementations, such user product interaction matrix may represent, for example, interactions between users in the set of users and products in the set of products. Of note, the product embedding matrix and the attribute embedding matrix may be based, for example, on the same product catalog, which may remain fairly static. As such, steps 208 and 210 may be repeatedly performed on an infrequent basis, such as when the product catalog changes (e.g., on a weekly or monthly basis). However, the user product interaction matrix may be based, for example, on interactions that occur fairly frequently. As such, step 212 may be repeatedly performed on a more frequent basis (e.g., daily).

In step 214, a product attribute matrix may be created. In various implementations, the product attributed matrix may be based, for example, on the product embedding matrix and the attribute embedding matrix. For example, the product attribute matrix may be based on a dot product of the product embedding matrix and the attribute embedding matrix. Alternatively, or in addition, the product attribute matrix may be created by using a neural network to lean a non-linear function and/or by using machine learning to learn directly from existing product catalogs and/or other available textual and/or visual data.

In step 216, a user attribute matrix may be created. In various implementations, the user attribute matrix may be based, for example, on the product attribute matrix and the user product interaction matrix. For example, the user attribute matrix may be based on multiplying the product attribute matrix and the user product interaction matrix.

In step 218, an attribute weight may be assigned to each product attribute. In various implementations, attribute weights may be based, for example, on the product attribute matrix. Generally, an attribute weight assigned to a product attribute may represent or otherwise indicate a preference of that product attribute as compared to other product attributes within the set of product attributes. Stated another way, attribute weights may represent, for example, a non-personalized rank of the product attributes.

In step 220, a user attribute weight for each product attribute may be assigned to each user. In various implementations, user attribute weights may be based, for example, on the user attribute matrix. Thus, for a particular user, the user attribute weights assigned for the various product attributes may represent or otherwise indicate that particular user's preference for the various product attributes. Stated another way, user attribute weights may represent, for example, a personalized rank of product attributes for a particular user.

In step 222, the set of products may be displayed in a ranked order to a particular user via a graphical user interface. In various implementations, the ranked order may be based, for example, on attribute weights assigned to product attributes and user attribute weights of the user. In this way, the ranked order may be based, for example, on both personalized preferences of the user and non-personalized preferences of all users.

The subject matter disclosed herein may enable estimating of product attribute preferences by taking into account interactions of a set of users with a set of products offered by a site, such as a retailer or other commerce website. As discussed above, embodiments disclosed herein may improve performance of a computing system, such as a commerce platform. For example, when a user is presented with preferred items (e.g., products and/or services) earlier, such as near “the top” of a product catalog, the user may more quickly select the items the user is looking for and more quickly complete the purchase process. By improving the efficiency of the buying process for each individual, the commerce platform may require or otherwise utilize fewer resources for any one individual and, in turn, the commerce platform may be able to provide services to a larger number of individuals.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method comprising:
identifying a set of users;
identifying a set of products offered to users of the set of users;
identifying a set of product attributes comprising product attributes associated with products in the set of products;
creating a product embedding matrix by embedding the set of products into a vector space, the product embedding matrix being a numerical representation of the set of products;
creating an attribute embedding matrix by embedding the set of product attributes into the vector space, the attribute embedding matrix being a numerical representation of the set of product attributes;
creating a user product interaction matrix based on historical interactions between users of the set of users and products of the set of products, the user product interaction matrix being a numerical representation of relationships between the set of users and the set of products;
creating a product attribute matrix based on the product embedding matrix and the user attribute embedding matrix;
creating a user attribute matrix based on the product attribute matrix and the user product interaction matrix;
assigning an attribute weight to each product attribute in the set of product attributes, each attribute weight being based on the product attribute matrix;
for each user in the set of users, assigning a user attribute weight for each product attribute in the set of product attributes, each user attribute weight being based on the user attribute matrix; and
displaying, via a graphical user interface, the set of products to a user in a ranked order based on the attribute weight of each product attribute in the set of product attributes and the user attribute weight for each product attribute in the set of product attributes assigned to the user.

2. The computer-implemented method of claim 1, wherein the set of users comprises users of a website associated with a retailer and the set of products are offered to the set of users by the retailer.

3. The computer-implemented method of claim 1, wherein embedding the set of products into the vector space comprises generating a vector for each product in the set of products by applying natural language processing techniques to each product.

4. The computer-implemented method of claim 1, wherein the product attribute matrix is a dot product of the product embedding matrix and the attribute embedding matrix.

5. The computer-implemented method of claim 1, wherein creating the product attribute matrix comprises utilizing a neural network to learn a non-linear function of elements of the product embedding matrix and elements of the attribute embedding matrix.

6. The computer-implemented method of claim 1, wherein creating the product attribute matrix comprises generating the product attribute matrix by applying machine learning techniques to a product catalog that defines attributes for the products.

7. The computer-implemented method of claim 1, wherein creating a user attribute matrix comprises multiplying the product attribute matrix and the user product interaction matrix.

8. A non-transitory machine-readable storage medium that provides instructions that, if executed by a processor, are configurable to cause the processor to perform operations comprising:
identifying a set of users;
identifying a set of products offered to users of the set of users;
identifying a set of product attributes comprising product attributes associated with products in the set of products;
creating a product embedding matrix by embedding the set of products into a vector space, the product embedding matrix being a numerical representation of the set of products;
creating an attribute embedding matrix by embedding the set of product attributes into the vector space, the attribute embedding matrix being a numerical representation of the set of product attributes;
creating a user product interaction matrix based on historical interactions between users of the set of users and products of the set of products, the user product interaction matrix being a numerical representation of relationships between the set of users and the set of products;
creating a product attribute matrix based on the product embedding matrix and the user attribute embedding matrix;
creating a user attribute matrix based on the product attribute matrix and the user product interaction matrix;
assigning an attribute weight to each product attribute in the set of product attributes, each attribute weight being based on the product attribute matrix;
for each user in the set of users, assigning a user attribute weight for each product attribute in the set of product attributes, each user attribute weight being based on the user attribute matrix; and
displaying, via a graphical user interface, the set of products to a user in a ranked order based on the attribute weight of each product attribute in the set of product attributes and the user attribute weight for each product attribute in the set of product attributes assigned to the user.

9. The non-transitory machine-readable storage medium of claim 8, wherein the set of users comprises users of a website associated with a retailer and the set of products are offered to the set of users by the retailer.

10. The non-transitory machine-readable storage medium of claim 8, wherein embedding the set of products into the vector space comprises generating a vector for each product in the set of products by applying natural language processing techniques to each product.

11. The non-transitory machine-readable storage medium of claim 8, wherein the product attribute matrix is a dot product of the product embedding matrix and the attribute embedding matrix.

12. The non-transitory machine-readable storage medium of claim 8, wherein creating the product attribute matrix comprises utilizing a neural network to learn a non-linear function of elements of the product embedding matrix and elements of the attribute embedding matrix.

13. The non-transitory machine-readable storage medium of claim 8, wherein creating the product attribute matrix comprises generating the product attribute matrix by applying machine learning techniques to a product catalog that defines attributes for the products.

14. The non-transitory machine-readable storage medium of claim 8, wherein creating a user attribute matrix comprises multiplying the product attribute matrix and the user product interaction matrix.

15. An apparatus comprising:
a processor; and
a non-transitory machine-readable storage medium that provides instructions that, if executed by a processor, are configurable to cause the processor to perform operations comprising:
identifying a set of users;
identifying a set of products offered to users of the set of users;
identifying a set of product attributes comprising product attributes associated with products in the set of products;
creating a product embedding matrix by embedding the set of products into a vector space, the product embedding matrix being a numerical representation of the set of products;
creating an attribute embedding matrix by embedding the set of product attributes into the vector space, the attribute embedding matrix being a numerical representation of the set of product attributes;
creating a user product interaction matrix based on historical interactions between users of the set of users and products of the set of products, the user product interaction matrix being a numerical representation of relationships between the set of users and the set of products;
creating a product attribute matrix based on the product embedding matrix and the user attribute embedding matrix;
creating a user attribute matrix based on the product attribute matrix and the user product interaction matrix;
assigning an attribute weight to each product attribute in the set of product attributes, each attribute weight being based on the product attribute matrix;
for each user in the set of users, assigning a user attribute weight for each product attribute in the set of product attributes, each user attribute weight being based on the user attribute matrix; and
displaying, via a graphical user interface, the set of products to a user in a ranked order based on the attribute weight of each product attribute in the set of product attributes and the user attribute weight for each product attribute in the set of product attributes assigned to the user.

16. The apparatus of claim 15, wherein embedding the set of products into the vector space comprises generating a vector for each product in the set of products by applying natural language processing techniques to each product.

17. The apparatus of claim 15, wherein the product attribute matrix is a dot product of the product embedding matrix and the attribute embedding matrix.

18. The apparatus of claim 15, wherein creating the product attribute matrix comprises utilizing a neural network to learn a non-linear function of elements of the product embedding matrix and elements of the attribute embedding matrix.

19. The apparatus of claim 15, wherein creating the product attribute matrix comprises generating the product attribute matrix by applying machine learning techniques to a product catalog that defines attributes for the products.

20. The apparatus of claim 15, wherein creating a user attribute matrix comprises multiplying the product attribute matrix and the user product interaction matrix.
